(19) United States
(12) Patent Application Publication
(10) Pub. No.: US 2022/0396703 A1
(43) Pub. Date: Dec. 15, 2022

(54) USE OF FLAKE-FORM EFFECT PIGMENTS FOR INCREASING THE INFRARED REFLECTION OF A DARK OR BLACK LAYER COMPOSITE

(71) Applicant: Merck Patent GmbH, Darmstadt (DE)

(72) Inventors: Christoph Landmann, Darmstadt (DE); Gianfranco Pironti, Darmstadt (DE)

(73) Assignee: Merck Patent GmbH, Darmstadt (DE)

(21) Appl. No.: 17/626,202

(22) PCT Filed: Jul. 9, 2020
(86) PCT No.: PCT/EP2020/069318

§ 371 Date: Jul. 25, 2022

(30) Foreign Application Priority Data
Jul. 12, 2019 (EP) 19186018.8

(51) Int. Cl. C09C 3/06; C09C 1/48

(52) U.S. Cl. CPC C09C 3/063; C09C 1/48

(57) ABSTRACT

The present invention relates to the use of flake-form effect pigments for increasing the infrared reflection of a dark or black layer composite, consisting of a substrate and a coating on the substrate, and to a dark or black layer composite of this type which has increased infrared reflection, in particular in the near infrared (NIR), compared with conventional dark or black layer composites which comprise only carbon-containing black pigments.

The present invention relates to the use of flake-form effect pigments for increasing the infrared reflection of a dark or black layer composite, consisting of a substrate and a coating on the substrate, and to a dark or black layer composite of this type which has increased infrared reflection, in particular in the near infrared (NIR), compared with conventional dark or black layer composites which comprise only carbon-containing black pigments.

For optical distance and speed measurement in road traffic, but also for other areas of application, so-called lidar systems (light detection and ranging) have frequently been employed for some time. By emitting laser pulses and subsequently detecting the light scattered back, these determine the distance of objects from the site of delivery of the laser pulse, for example with reference to the light transit time. In order to be recognisable for a system of this type, the objects to be detected must be able to reflect the light beam emitted by the laser source to a certain extent, since otherwise the object or obstacle cannot be located reliably for the lidar system. In particular for the increasing number of motor vehicles that have a modern driving assistance system, but also for current and future autonomously controlled motor vehicles, it is necessary that other motor vehicles, traffic control devices or obstacles on the carriageway are recognised quickly, in good time and reliably and that their speeds can be analysed.

Of major importance for the recognisability of motor vehicles for laser-supported systems of this type is the vehicle paint used for exterior vehicle parts, which in the ideal case reflects the laser pulse emitted by a lidar system to a high proportion, so that the motor vehicle provided therewith is recognised by the lidar system and can be assessed in distance and speed. Pale motor vehicle paints generally contain constituents, in particular colouring pigments, which already satisfy the corresponding conditions. Still popular, however, are dark or black vehicle paints, which usually contain a significant amount of carbon black pigments, whose reflection in the infrared wavelength range, in particular in the NIR wavelength range which is customary here, is, however, very low or virtually undetectable, so that the motor vehicles provided therewith cannot be detected by the lidar systems currently employed, which emit laser pulses in a wavelength region around 900 nm and in some cases also in a wavelength region around 1550 nm.

It is obvious that the further increase in driving assistance systems and the future further development in the area of autonomous driving require that all traffic obstacles, irrespective of type and colour, can be detected by the corresponding detection systems and reliably assessed. There is therefore a need for dark or black motor vehicle paints or coatings on objects which may represent traffic obstacles, which contain constituents which, with a virtually unchanged colouration, reflect infrared light emitted by laser radiation to such an extent that the light scattered back can be detected by the corresponding detection systems and evaluated.

The object of the invention therefore consists in providing ingredients for dark or black layer composites formed, for example, by coatings on motor vehicle parts or other objects, which enable an increase in infrared reflection compared with conventional dark or black layer composites of this type, in particular in the NIR wavelength range.

A further object of the invention consists in providing dark or black layer composites which consist of coatings on motor vehicle parts or other objects, which have increased infrared reflection, in particular in the NIR wavelength range, compared with commercially available comparative layer composites of the same colour, so that they can be detected by the corresponding detection systems, preferably by lidar systems, and evaluated.

The object of the invention is achieved by the use of flake-form effect pigments for increasing the infrared reflection of a dark or black layer composite, consisting of a substrate and a coating on the substrate, where the coating, in addition or as an alternative to a carbon-containing black pigment, comprises at least one flake-form effect pigment which has at least one Fe₃O₄-containing layer or FeTiO₃-containing layer on a flake-form Al₂O₃ or SiO₂ support, where the layer composite has an L*15 value in the range from 1 to 60, and where the infrared reflection of the layer composite is increased, at least in the wavelength range from 850 nm to 1570 nm, compared with a dark or black layer composite comprising a substrate and a coating where the layer composite comprises the carbon-containing black pigment, has an L*15 value in the said range and does not comprise at least one flake-form effect pigment.

In addition, the object of the invention is also achieved by a dark or black layer composite having increased infrared reflection, consisting of a substrate and a coating, where the coating, in addition or as an alternative to a carbon-containing black pigment, comprises at least one flake-form effect pigment which has at least one Fe₃O₄-containing layer or FeTiO₃-containing layer on a flake-form Al₂O₃ or SiO₂ support, where the dark or black layer composite has an L*15 value in the range from 1 to 60 and where the infrared reflection of the coating is higher, at least in the wavelength range from 850 nm to 1570 nm, than the infrared reflection of a comparative layer composite which comprises the carbon-containing black pigment, has an L*15 value in the said range and does not comprise at least one flake-form effect pigment.

The invention therefore relates to the use of specific flake-form effect pigments for increasing the infrared reflection of dark or black layer composites which consist of a substrate and a coating located on the substrate.

Infrared light refers to the wavelengths of light from 780 nm. The wavelength range directly adjacent to the region of visible light (up to about 780 nm) is called near infrared (NIR) and includes the part-ranges IR-A (780 to 1400 nm) and IR-B (1400 to 3000 nm). Current lidar systems generally work with laser pulses in the region of 900±50 nm, but some lidar systems that work with longer wavelengths of 1550±20 nm are also already known. It is therefore desirable to have available materials which are able to increase the infrared reflection of dark or black layer composites which consist of a substrate and a coating arranged thereon, either in the region around 900 nm and/or in the region around 1550 nm.

The present inventors have surprisingly found that certain flake-form effect pigments are able to meet these requirements if they are employed specifically in coatings on substrates and are varied in composition as needed.

Flake-form effect pigments that are employed in coatings of dark or black layer composites should basically as far as possible likewise have a dark or black mass tone, which is supplemented, but not reduced, by any interference colours. The flake-form effect pigments to be employed in the coatings of the present dark or black layer composites accordingly in each case have at least one Fe₃O₄-containing layer or FeTiO₃-containing layer, which provide the effect pigments with a dark-grey or black absorption colour (mass tone), on a flake-form support particle. Any additional layers present on the support particle, which generally consist of metal oxides and/or metal oxide hydrates, should not lighten the mass tone.

It has now been found, however, that the flake-form support particles of the effect pigments are of particular importance for the targeted design of the infrared reflection of the coating comprising the flake-form effect pigments in a dark or black layer composite, and thus the infrared reflection of the entire layer composites. These support particles must consist of materials which facilitate a uniform layer thickness over the entire extent of the support particle, where it should, in addition, be possible for this layer thickness to be set specifically during the production process of the support particles and not to vary greatly over the batch. In addition, it has been found that only certain materials are suitable to serve as support particles for the specific effect pigments and at the same time to make their own contribution to increasing the infrared reflection, in particular in the target NIR wavelength range.

In the sense of the invention, suitable support materials for the flake-form effect pigments to be employed have proven to be aluminium oxide (Al₂O₃) and silicon dioxide (SiO₂), which are present in the flake-form support particles in a proportion of at least 80% by weight, based on the weight of the support particles. The proportion of silicon dioxide or aluminium oxide is preferably at least 90% by weight, particularly preferably at least 95% by weight, based on the weight of the support particles.

In the case of Al₂O₃ support particles, these may comprise from 0.1 to 10% by weight, preferably from 0.1 to 5% by weight, based on the weight of the support particles, of foreign constituents. These are the oxides or oxide hydrates of Ti, Sn, Si, Ce, Ca, Zn, In and/or Mg. Preference is given to the use of Al₂O₃ support particles which, besides Al₂O₃, also comprise from 0.1 to 5% by weight, based on weight of the support particles, of TiO₂. Based on SiO₂ support particles, these consist of at least 80% by weight SiO₂ and may comprise from 0 to 20% by weight of silicon oxide hydrate and possibly traces of foreign ions, so that the sum of these constituents is 100% by weight.

All said supports, although they may comprise a certain proportion by weight of other materials, are referred to below as Al₂O₃ supports or SiO₂ supports. The maximum of the infrared reflection in the wavelength range 850 nm to 1570 nm for the dark or black layer composite which comprises the flake-form effect pigments in a coating can be set specifically via the thickness of the flake-form support particles.

Flake-form Al₂O₃ supports having an average geometrical thickness in the range from 120 to 400 nm are suitable for use as support particles for the flake-form effect pigments used in accordance with the invention. While an increase in the infrared reflection in the wavelength regions 900±50 nm and 1550±20 nm can be achieved with the resultant flake-form effect pigments in the case of average geometrical thicknesses of the support particles in the range from 120 to 150 nm, with the focus on the wavelength region 900±50 nm, average geometrical thicknesses of the support particles in the range from 200 to 350 nm give high infrared reflection in the wavelength region of 1550±20 nm, whereas in the case of average geometrical thicknesses in the range from 350 to 400 nm the maximum of the infrared reflection is shifted into the wavelength region 900±50 nm. Since, as already mentioned above, the spread in the geometrical thickness of the individual Al₂O₃ support particles in the mass of support particles to be employed should only vary within narrow limits, the Al₂O₃ supports employed are preferably monocrystalline support particles, in the production of which both the layer thickness variance of the particles and also the variance of the particle size can be controlled precisely via the production process. In this sense, Al₂O₃ support particles produced by the process described in EP 763 573 A2 are particularly suitable for use in the present invention.

Flake-form SiO₂ supports having an average geometrical thickness in the range from 150 to 500 nm are suitable for use as support particles for the flake-form effect pigments used in accordance with the invention. Here too, the spread in the geometrical thicknesses of the individual support particles in the mass of support particles to be employed should be low and it should be possible for the geometrical layer thickness of the support particles to be controlled precisely via the production process. For this reason, the belt process in accordance with WO 93/08237 A1 described below is particularly suitable for the production of the SiO₂ support particles and is therefore preferred.

In the case of SiO₂ supports, the maxima of the infrared reflection change slightly depending on the average geometrical thickness of the support particles, in a similar manner to the Al₂O₃ supports, but the ranges are somewhat shifted with 150 to 200 nm for increased reflection values in the wavelength regions 900±50 nm and 1550±20 nm with focus on the wavelength region 900±50 nm, an average geometrical thickness of 250 to 400 nm for high reflection values in the wavelength region 1550±20 nm, and an average geometrical thickness of 450 to 500 nm for the maximum of the infrared reflection in the wavelength region 900±50 nm.

Besides the at least one Fe₃O₄-containing layer or FeTiO₃-containing layer, the flake-form effect pigments to be employed in accordance with the invention may also have other layers on the support particle. These preferably consist of metal oxides, metal oxide hydrates or mixed metal oxides and are selected from silicon dioxide, silicon dioxide hydrate, titanium dioxide, titanium dioxide hydrate, tin dioxide, tin dioxide hydrate, iron(III) oxide, goethite (FeOOH) and/or mixed oxides comprising titanium dioxide with tin dioxide or comprising titanium dioxide with iron(III) oxide.

These layers can be located both between the support particle and the Fe₃O₄-containing layer or FeTiO₃-containing layer and also alternatively above this layer on the support particle, or, however, layers of the said type which are different from one another are located between the support particle and the respective Fe₃O₄-containing layer or FeTiO₃-containing layer and additionally also above this layer.

In addition, the flake-form effect pigments to be employed can also have so-called post-coatings, which can be of an inorganic and/or organic nature, as the final layer on their respective surface. Such post-coatings are well known in the area of effect pigments. They are applied to the surface of the effect pigments in order to improve their chemical or mechanical stability, in order to simplify incorporation thereof into various application media, in order to achieve a desired floating behaviour or for various other reasons of better handling ability and durability. These post-coatings are frequently based on inorganic metal oxides or metal oxide hydrates or on suitable organic substances and are applied to the surface of the effect pigments in layer thicknesses of only a few nanometres (frequently 1 to 20 nm). They generally do not influence the colour, gloss and flop properties of the effect pigments or only do so to a minor extent and are therefore of low importance for the functional and colouristic properties of the effect pigments.

Flake-form effect pigments which are suitable for the use according to the invention are described in greater detail, in particular with respect to flake-form effect pigments built up on Al₂O₃ supports, in the patent specifications DE102014003975 A1, WO 2012/076110 A1 and in the patent application EP 19163126.6 previously filed by the present patent applicant. The patent specifications indicated disclose both the suitable layer sequences and layer thicknesses on the support particles and also the respective preferred ranges of the particle sizes, as well as the corresponding production processes. For this reason, a detailed description will not be given here and to this extent reference is expressly made to the said patent documents, the disclosure content of which in this respect is intended to be incorporated herein in its full scope.

In addition, suitable flake-form effect pigments are commercially available as commercial products from Merck KGaA, for example under the names Xirallic® NXT M260-60 WNT Panthera Silver and Xirallic® NXT M260-70 SW Amur Black.

Flake-form effect pigments of this type which are built up on Al₂O₃ support particles are preferably employed for the use in accordance with the present invention.

With regard to flake-form effect pigments built up on SiO₂ support particles, the support flakes are preferably produced by means of a belt process, which is described in greater detail in WO 93/08237 A1. In this process, the support flakes are produced from an inorganic SiO₂ precursor material (for example sodium water-glass solution), where the precursor is applied to the belt, converted into the oxidic form or into the oxide hydrate using acid, solidified and subsequently detached from the belt. The geometrical layer thickness of the flakes is set via the application amount or wet layer thickness of the precursor layer, which is possible very precisely. The SiO₂ flakes are subsequently coated in the same manner with the subsequent layers, including the Fe₃O₄-containing layer or the FeTiO₃-containing layer, as described in the above-mentioned patent applications by the present patent applicant for effect pigments based on Al₂O₃ flakes.

The flake-form effect pigments to be employed in accordance with the invention generally have particle sizes in the range from 1 to 200 μm, with particle sizes between 5 and 150 μm, preferably 7 to 100 μm, and in particular between 7 and 50 μm, being particularly preferred. Average particle sizes (d₅₀) in the range from 12 to 25 μm are preferred. The particle size is regarded as the length of the longest axis of the pigment particle.

The particle size of the flake-form effect pigments is preferably determined by a laser diffraction method, which is generally familiar and has the advantage of also being able to determine the particle size distribution of the effect pigments. For the effect pigments employed in accordance with the invention, the particle sizes were determined using a Malvern Mastersizer 3000, APA 300 (product from Malvern Instruments, Ltd., UK).

The flake-form effect pigments to be employed in accordance with the invention generally have a form factor (ratio of the average particle size to the average thickness of the particles) in the range from 5 to 200.

Depending on the geometrical thickness of the corresponding support particles that has been set, both the particle size and the form factor of the specific effect pigments can, however, vary in a narrower range within the ranges described here, as is described in specific terms, for example, in the above-mentioned patent applications by the present patent applicant. Reference is again expressly made to corresponding details in the said patent applications.

Thus, for example, WO 2012/076110 A1 describes black flake-form effect pigments based on a flake-form aluminium oxide support particle which has an aspect ratio of at least 85 and is coated with metal oxides, where one layer of the coating consists of Fe₃O₄. The geometrical thickness of the Fe₃O₄ layer is in the range from 50 to 250 nm. The support particles of these effect pigments have an average geometrical thickness in the range from 50 to 200 nm and an average particle size of less than 20 μm. These flake-form effect pigments are, in accordance with the present invention, especially suitable for increasing the infrared reflection of a dark or black layer composite, consisting of a substrate and the coating on the substrate, in the wavelength region 900±50 nm when they are employed in the coating.

The as yet unpublished patent application by the patent applicant with the file reference EP 19163126.6 describes blue-black flake-form effect pigments, inter alia based on flake-form aluminium oxide support particles, in which the uncoated support particles have an intrinsic green interference colour. These support particles are likewise coated with metal oxides, where the coating has a magnetite layer. This magnetite layer has a geometrical thickness in the range from 80 to 230 nm. Blue-black flake-form effect pigments of this type whose Al₂O₃ support particles have an average geometrical thickness in the range from 180 to 260 nm and which have particle sizes in the range from 5 to 200 μm are preferably suitable for use in the present invention. These effect pigments are particularly suitable for increasing the infrared reflection of a dark or black layer composite in the wavelength region 1550±20 nm, when they are employed in the coating on the substrate.

Geometrical thickness of the support particles or of a layer on the support particle is taken to mean the directly measurable thickness of the support particles or layer from electron-microscopic SEM photomicrographs of the cross section of the support particles or flake-form effect pigments. The geometrical thickness of the support particles or the geometrical layer thickness of the layer on the support particle is generally indicated in nm. The average value is determined by measuring at least 1000 particles.

The geometrical thickness of the support particles employed in accordance with the present invention or the geometrical layer thickness of layers on the support particle of the flake-form effect pigments is determined by this method.

For the purposes of the invention, a dark or black layer composite is taken to mean a layer composite, consisting of a substrate and a coating located on the substrate, which comprises colouring components optionally in the substrate itself and in addition either in a single layer of the coating on the substrate or in a system of two layers, applied one on top of the other, of the coating on the substrate and has an L*15 value in the CIELAB L*a*,b* colour space system in the range from 1 to 60, preferably in the range from 5 to 50, measured from the coating side. The L* 15 value here relates to the lightness value at a viewing angle which has a separation in the direction of the light source of 15 degrees from the specular angle of a sample measured using a goniospectrophotometer at an illumination angle of 45°. For the purposes of the invention, the carbon-containing black pigment and the flake-form effect pigment are regarded as colouring components which are determinative for the definition. Further colouring components may optionally be present in the coating in the form of inorganic and/or organic absorption pigments, dyes or in the form of further effect pigments, so long as the requirements of the L* 15 value of the layer composite are satisfied. The L* 15 value in the CIELAB system represents a value for the lightness of the sample close to the specular angle and therefore generally has the highest lightness value that this sample can have, depending on the viewing angle. The higher the value, the lighter the colouristic impression of the sample. Conversely, a sample having a low L* 15 value exhibits a dark or black colour impression. In the range claimed, the visual colour impression of the samples is dark or black.

(For the present invention, a sample is produced as follows: black- and white-coated test panels from Leneta (Leneta T12G Metopac, carbon-containing black pigment present in the black coating) are in each case coated over the entire area with a coating composition which, besides a commercially available binder and a solvent (varnish WBC000 from MIPA SE, Germany), comprises a pigment mass concentration PMC of 18% of dry matter of flake-form effect pigments according to the invention. The coating is carried out by means of a pneumatic spray process with a dry-layer thickness in the range from 12 to 15 μm. After thermal curing of this paint layer, a colourless clear coat (MIPA CC4, MIPA SE) is applied to the paint layer (dry-layer thickness about 50 μm). The samples obtained in this way are measured using a BYK-mac i goniospectrophotometer (BYK Gardner GmbH, DE) in SMC 5 mode over the part of the test panel that has been pre-coated black. For comparative purposes, samples are produced by the same process, but with a different pigment mass concentration).

The substrates employed in accordance with the invention are films, plates or mouldings made from plastic, metal or from composite materials, where the respective substrate can optionally have been pre-treated and/or pre-coated, for example by means of electrostatic pre-treatment and/or one or more primer layers. The substrates employed in accordance with the invention often do not contain a carbon-containing black pigment either in the substrate material itself or in any pre-coating present. In accordance with the present invention, however, a carbon-containing black pigment may be present both in the substrate material (for example in the case of plastic films, plates or mouldings that have been mass-coloured black) and/or in a primer layer.

Besides the carbon-containing black pigment optionally present and the at least one flake-form effect pigment of the said type, the coating of the dark or black layer composite, which is a dry, solid coating, also comprises at least one binder. Depending on the intended application of the layer composite, aqueous, solvent-containing or radiation-curing binder systems of all known types can be used. The only restrictive factor here is that the binder system must be suitable for the particular intended application of the layer composite and the method used for application of the coating to the substrate. Since the intended effect of the layer composite according to the invention is achieved irrespective of the binder system used, a further description of the possible binder systems will be omitted.

Besides at least one binder, the coating of the layer composite according to the invention may also comprise the conventional additives, assistants, fillers and optionally colourants which are usually used in various coating compositions. It must merely be ensured here that the colour impression of a dark or black layer composite, which is essentially determined by the coating located on the substrate, and which is defined via the respective L* 15 value, must be retained, so that all additionally employed substances which may influence the colouring of the coating must be subordinate to the requirement of observance of the L* 15 value. Otherwise, the additionally introduced substances can be matched to the requisite optical, mechanical or functional properties of the coating resulting in each case.

The corresponding coating can be applied to the substrate by means of any conventional coating method. Mention may be made here by way of example of electrostatic or pneumatic spray methods, coil-coating methods, dip-coating methods, spin coating, held-coating methods and also diverse printing processes (screen, pad, ink-jet printing). The appropriate coating method for the particular case is selected depending on the desired application of the dark or black layer composite and does not play a significant role for the intended action of the coating. It goes without saying that the coating composition used for the particular application method may, besides the above-mentioned constituents, optionally also comprise solvents or solvent mixtures, which, however, are no longer present in the solidified, dried or cured coating.

Furthermore, the coating may, depending on need, also be applied to the substrate by means of an injection-moulding process or a reversed injection moulding process. In this case, the ingredients of the particular coating composition that are necessary in addition to the carbon-containing black pigment optionally employed and the at least one flake-form effect pigment are matched to the specific process and selected routinely in accordance with the knowledge of the person skilled in the art.

The coating on the substrate, which together form the layer composite according to the invention, has a total thickness of at least 30 μm, preferably in the range from 50 to 230 μm. It can have a single- or multilayered structure and preferably has a multilayered structure. At least the layer of the coating that comprises the flake-form effect pigments has a thickness in the range from 1 to 60 μm, preferably from 3 to 30 μm, and in particular from 10 to 20 μm. If one of the layers of the multilayer system comprises only the carbon-containing black pigment, but not the at least one flake-form effect pigment, this layer usually has a thickness of 3 to 20 μm, preferably 7 to 12 μm.

Unpigmented clear-coat layers, which can frequently form the outermost layer of a multilayer system, have a layer thickness of at least 35 μm, which can be extended to a range of up to 150 μm.

All layer-thickness indications naturally relate to the respective dry-layer thicknesses.

The use of flake form effect pigments which each case have at least one Fe₃O₄-containing layer or FeTiO₃-containing layer on a flake-form support particle, where the support particle is in each case a flake-form Al₂O₃ or SiO₂ support, increases the infrared reflection of the corresponding dark or black layer composite, at least in the wavelength range from 850 to 1550 nm, compared with a dark or black layer composite which likewise consists of a substrate and a coating and comprises a carbon-containing black pigment, but does not comprise the said flake-form effect pigments.

The extent of the increase in the infrared reflection in the said wavelength range is dependent on the specific type of flake-form effect pigments, on the mixing ratio of the flake-form effect pigments if these are employed in mixtures, or also on whether a carbon-containing black pigment is present in the respective coating composition in addition to the flake-form effect pigments.

Increases in the infrared reflection by at least 10% in the said target wavelength range can be expected.

The NIR reflection of the coating side of the dark or black layer composite according to the invention, consisting of a coating on a substrate, is determined independently of the angle by means of an Ulbricht sphere and a PerkinElmer, Inc., Lambda 900 UV/VIS/NIR spectrophotometer and evaluated using integrated software.

The carbon-containing black pigment employed in industrial coatings is frequently colour blacks of various particle sizes. Colour blacks are also regarded as preferred carbon-containing black pigments in respect of the present invention. Mention may be made here by way of example of the commercially available colour-black grades with the trade names Emperor® 2000 (Worlée-GmbH), Spezial Black® 6 and Spezial Black® 100 (Orion Engineered Carbons) used for experiments and comparative experiments.

However, the use of Perylene Black (Pigment Black 32) as carbon-containing black pigment has also proven particularly positive for the present invention since this pigment exhibits high reflection in the NIR region, even in coatings, and therefore further enhances the effect of the increase in infrared reflection, in particular in the NIR wavelength range, that is achieved by the specific flake-form effect pigments used in accordance with the invention.

The dark or black coatings on substrates that are employed for the layer composite according to the invention can have a single-layered or multilayered structure. They are preferably part of a multilayer system on the substrate, which, besides the single- or two-layered dark or black coating, can also have, for example, a final clear-coat layer and/or further interlayers on the substrate.

This gives rise to a number of basic embodiments for the layer composite according to the invention. All indications of layer thicknesses and layer weights relate to the dry-layer thicknesses or the weight of the particular dry layer respectively.

In a first embodiment, the dark or black layer composite comprises no carbon containing black pigment. Neither the substrate, including any pre-coatings present, nor the coating comprises a carbon-containing black pigment, but instead the coating comprises merely the at least one flake-form effect pigment of the said type. In this embodiment, a high pigment mass concentration of the corresponding flake-form effect pigment in the coating is essential in order to achieve a dark or black colour impression of the layer composite. The pigment mass concentration of the flake-form effect pigment should therefore be at least 15% by weight, based on the weight of the layer of the coating that comprises the flake-form effect pigment. The coating here may optionally be a multilayer system.

In a second embodiment, a carbon-containing black pigment is present in the substrate, but not in the coating of the layer composite. The term “substrate” here encompasses both the body of the substrate (for example in the form of mass-coloured plastic films or mouldings) and also any pre-coatings (primer layers) present. By contrast, the coating on the substrate comprises merely at least one flake-form effect pigment of the type described (naturally one type, not a single pigment particle). The coating here may optionally be a multilayer system.

In a third embodiment, a carbon-containing black pigment and the at least one flake-form effect pigment are present together in a layer of the coating. It is possible here, but not necessary, for the substrate to which the coating according to the invention is applied itself to comprise a carbon-containing black pigment or to be pre-coated with a layer comprising a black pigment of this type. Further layers and advantageously a final clear-coat layer may optionally be part of the coating, so long as the L* 15 value of the layer composite is in the range from 1 to 60 and the layer composite as a whole therefore satisfies the requirement of a dark or black layer composite.

In a fourth embodiment, the carbon-containing black pigment and the at least one flake-form effect pigment are present in each case in two layers of the coating which are separated from one another and which are preferably arranged directly on one another on the substrate. It is possible here, but not necessary, for the substrate to which the coating is applied itself to comprise a carbon-containing black pigment. Firstly, a layer which comprises a carbon containing black pigment, comprises none of the said flake-form effect pigment and generates an L* 15 value of <10 in the CIELAB L*;a*,b* colour space if the substrate coated therewith is measured as described above, is applied as coating to the substrate. A colour-coat layer which comprises at least one (one type) of the flake-form effect pigments described above is preferably applied directly to a black base-coat layer of this type. In this embodiment, the colour-coat layer comprises no carbon-containing black pigment. A plurality of different types of the said flake-form effect pigments can be employed in the colour-coat layer, which is in some cases also advantageous, as described below. Here too, further layers and advantageously a final clear-coat layer can optionally be applied as part of the coating, so long as the L* 15 value of the overall layer composite is in the range from 1 to 60 and the layer composite as a whole therefore satisfies the requirement of a dark or black layer composite.

In each of the said embodiments, the layer that comprises the flake-form effect pigments may also comprise at least two flake-form effect pigments of the said type which are different from one another. In accordance with the present invention, these are flake-form effect pigments which are different from one another if they differ in the material of the support (Al₂O₃ or SiO₂), in the average geometrical thickness of the support, in the material of the iron-containing layer (Fe₃O₄-containing or FeTiO₃-containing) or in their particle size. It is also possible for two or more of the differentiating features to be present simultaneously.

It has, for example, proven advantageous for two flake-form effect pigments which are different from one another, which in each case have a layer of Fe₃O₄ on an Al₂O₃ support, but have a different average geometrical thickness of the support and different particle sizes, to be employed together in the layer on the substrate that comprises the flake-form effect pigments. In this case, the different average geometrical thicknesses of the supports should in each case belong to one of the above-mentioned ranges with which the reflection maximum in the wavelength region of 900±50 nm or 1550±20 nm can be influenced specifically.

As already explained above, flake-form, Al₂O₃-containing supports having average geometrical thicknesses of the support particles in the range from 120 to 150 nm are suitable, with the resultant flake-form effect pigments, for increasing the infrared reflection both in the wavelength regions 900±50 nm and also 1550±20 nm, with the focus being on the wavelength region 900±50 nm, whereas high infrared reflection in the wavelength region of 1550±20 nm can be obtained with average geometrical thicknesses of the support particles in the range from 200 to 350 nm and the maximum of the infrared reflection in the wavelength region 900±50 nm can be obtained with average geometrical thicknesses in the range from 350 to 400 nm.

If, for example, two different types of flake-form effect pigments whose Al₂O₃ support particles have average geometrical thicknesses on one hand in the range from 120 to 150 nm and on the other hand in the range from 200 to 350 nm, with a narrow layer-thickness variance of the support particles in each case, are now employed, the desired reflection maximum of either 900±50 nm or 1550±20 nm can be set specifically via the relative percentage proportion by weight of the respective flake-form effect pigment in the total weight of the two flake-form effect pigments in the layer comprising them.

In this way, or also through the use of other flake-form effect pigments of the said type which are different from one another, reflection maxima in the wavelength region 900±50 nm or in the wavelength region 1550±20 nm can be set specifically with a specific coating on a substrate in accordance with the present invention, so that correspondingly resultant layer composites can be matched to the respective detection system as needed.

It is likewise advantageous for flake-form effect pigments which have an FeTiO₃ layer on an Al₂O₃ or SiO₂ support to be employed, within a layer of the coating, together with a carbon-containing black pigment and/or with a flake-form effect pigment which has an Fe₃O₄ layer on an Al₂O₃ or SiO₂ support, since the L*15 value of the resultant layer composite can thus readily be set in the target range via the coating.

The present invention also relates to a dark or black layer composite, consisting of a coating on a substrate, which has increased infrared reflection, where the coating, in addition or as an alternative to a carbon-containing black pigment, comprises at least one flake-form effect pigment which has at least one Fe₃O₄-containing layer or FeTiO₃-containing layer on a flake-form Al₂O₃ or SiO₂ support, where the dark or black layer composite has an L*15 value in the range from 1 to 60 and where the infrared reflection of the layer composite, at least in the wavelength range 850 to 1570 nm, is higher than the infrared reflection of a comparative layer composite which comprises the carbon containing black pigment, has an L* 15 value in the said range and which does not comprise at least one flake-form effect pigment.

A layer composite consisting of a substrate and a coating is in accordance with the present invention regarded as dark or black if it has, measured from the coating side, an L*15 value in the range from 1 to 60, preferably in the range from 5 to 50. As already explained above, the L* 15 value relates to the lightness value at a viewing angle which has a separation in the direction of the light source of 15 degrees from the specular angle of a sample measured using a goniospectrophotometer at an illumination angle of 45°.

The L* 15 value in the CIELAB system represents a value for the lightness of the sample close to the specular angle and therefore generally has the highest lightness value that this sample can have, depending on the viewing angle. In the claimed range, the visual colour impression of the samples is dark or black.

The measurement of the samples can be carried out using any commercially available goniospectrophotometer. For the present invention, the measurement results are based on measurements using a BYK-mac i goniospectrophotometer (BYK Gardner GmbH, DE) in SMC 5 mode over the part of the test panel that has been pre-coated black, as already described above.

The infrared reflection of the dark or black layer composite according to the invention is higher, at least in the wavelength range from 850 to 1570 nm, than the infrared reflection of a comparative layer composite which comprises a carbon-containing black pigment, but does not comprise the flake-form effect pigments, and otherwise has a comparable structure and a comparable composition, and in addition has an L*15 value in the range from 1 to 60. The infrared reflection of the layer composite according to the invention can, however, optionally also be increased for wavelength ranges of infrared light outside the said limit values, which may be of importance, in particular, for components in motor vehicle interiors, which would have the consequence of less heating of the corresponding motor vehicle interior in such a case compared with commercially available dark or black comparative components.

The infrared reflection of a layer composite according to the invention is preferably higher, at least in the wavelength region 900±50 nm or in the region 1550±20 nm, than the infrared reflection of the corresponding comparative layer composite. However, the infrared reflection of a layer composite according to the invention may likewise be higher than the infrared reflection of the corresponding comparative layer composite both in the wavelength region 900±50 nm and also in wavelength region 1550±20 nm.

As already stated above, the reflection maximum of the respective resultant layer composite can be predetermined specifically through a suitable choice of the particular flake-form effect pigments, in particular through a suitable choice of the geometrical thicknesses of the support particles and through the use of different types of the particular flake-form effect pigments in suitable mixing ratios in the selected coating. It goes without saying that, if different flake-form effect pigments which tend to lead to different reflection maxima are used together, the greater relative proportion by weight of the respective flake-form effect pigment determines the position of the reflection maximum of the resultant layer composite. The relative weight ratios can be set in any conceivable ratio here.

The use of flake-form effect pigments which are different from one another in the coating of the dark or black layer composite according to the invention can therefore be particularly advantageous. This is one of the preferred embodiments of the invention.

Four embodiments which are different from one another and have already been described in greater detail above can in principle be employed for the dark or black layer composite according to the invention. Repetition will therefore be omitted.

The layer of the substrate coating which comprises the flake-form effect pigments comprises them in a proportion by weight in the range from 1 to 60% by weight, preferably 5 to 35% by weight, based on the weight of this (dry) layer, irrespective of whether a carbon-containing black pigment is present in this layer or not.

The dark or black layer composite according to the invention, consisting of a coating on a substrate, can advantageously be employed everywhere where dark or black coatings on any desired substrates are intended to have increased reflection in the infrared region, in particular in the NIR wavelength region, compared with commercially available comparative coatings. This increased IR reflection makes corresponding layer composites comprising substrate and coating which have been provided with the coating having the composition according to the invention suitable for recognition by means of conventional laser detection systems, such as, for example, the known lidar process. Thermal energy from solar radiation can also be absorbed in reduced form via the increased infrared reflection. The layer composite according to the invention is therefore particularly suitable for use as internal and external motor vehicle part of all types, but also as traffic control device or part thereof. These can be any desired types of motor vehicle.

However, the layer composites according to the invention find particular use as bodywork parts and/or other external components of a motor vehicle, where the motor vehicle has a driving assistance system or is autonomously controlled. Here, the layer composite according to the invention facilitates mutual recognition of this type of motor vehicles by means of laser-controlled detection systems.

The invention is intended to be explained in greater detail below with reference to examples, but is not intended to be restricted thereto.

### EXAMPLES

Various samples of coatings are produced as follows:

Black- and white-coated test panels from Leneta (Leneta T12G Metopac, carbon-containing black pigment present in the black coating) are in each case coated over the entire area with a coating composition which, besides a commercially available binder and a solvent (varnish WBC000 from MIPA SE, Germany), comprises a pigment mass concentration PMC of 18% of dry weight of flake-form effect pigments in accordance with the invention. The coating is carried out by means of a pneumatic spray process with a dry-layer thickness in the range from 12 to 15 μm. After thermal curing of this colour layer, a colourless clear coat (MIPA CC4, MIPA SE) is applied to the colour layer (dry-layer thickness about 50 μm). The samples obtained in this way are measured using a BYK-mac i goniospectrophotometer (BYK Gardner GmbH, DE) in SMC 5 mode over the part of the surface of the test panel that has been pre-coated black. For comparative purposes, samples are produced by the same process, but with a different pigment mass concentration).

### Example 1

Comparison of the L15* values and IR reflection values in the wavelength region 900±50 nm and in the wavelength region of 1550±20 nm of samples which comprise only a carbon-containing black pigment, and samples which comprise only a flake-form effect pigment. The results are shown in Table 1.

TABLE 1

| | | | Reflection | Reflection |
|---|---|---|---|---|
| PMC | | | 900 ± 50 nm | 1550 ± 20 nm |
| (%) | Pigment | L*15 value | (%) | (%) |
| 3.5 | Emperor ® | 1.1 | 5.4 | 5.8 |
| | 2000 | | | |
| 3.5 | Spezial | 2.3 | 5.3 | 5.7 |
| | Black ® 6 | | | |
| 3.5 | Spezial | 5.3 | 4.9 | 5.9 |
| | Black ® 100 | | | |
| 18.0 | Support Al₂O₃, | 45.0 | 9.5 | 18.8 |
| | about 220 nm, | | | |
| | Fe₃O₄ | | | |
| 18.0 | Support Al₂O₃, | 46.2 | 21.6 | 12.1 |
| | about 150 nm, | | | |
| | Fe₃O₄ | | | |

The results show that layer composites which have coatings with commercially available colour black can achieve low L*15 values in a stable manner, but the percentage reflection of light in the wavelength regions 900±50 nm and 1550±20 nm is very weak. By contrast, the sole use of flake-form effect pigments used in accordance with the invention (the average geometrical thickness of the supports and the type of iron-containing layer is indicated) still ensure lightness values L* 15 which satisfy the requirement “dark or black”, but lead to significantly improved reflection values in the defined wavelength regions.

### Example 2

The influence of the flake-form effect pigments used in accordance with the invention on the lightness value L*15 and the reflection behaviour of the corresponding layer composite in the defined wavelength regions is investigated when carbon-containing black pigment and flake-form effect pigment are present together in a single layer of the coating. The results are shown in Table 2.

TABLE 2

| | | | Reflection | Reflection |
|---|---|---|---|---|
| PMC | | | 900 ± 50 nm | 1550 ± 20 |
| (%) | Pigment | L*15 value | (%) | nm (%) |
| 3.5 | Emperor ® | 26.5 | 7.2 | 12.6 |
| | 2000 | | | |
| 18.0 | Support Al₂O₃, | | | |
| | about 220 nm, | | | |
| | Fe₃O₄ | | | |
| 3.5 | Emperor ® | 7.7 | 5.8 | 6.9 |
| | 2000 | | | |
| 1.8 | Support Al₂O₃, | | | |
| | about 220 nm, | | | |
| | Fe₃O₄ | | | |
| 3.5 | Emperor ® | 25.9 | 9.6 | 10.5 |
| | 2000 | | | |
| 9.0 | Support Al₂O₃, | | | |
| | about 220 nm, | | | |
| | Fe₃O₄ | | | |
| 9.0 | Support Al₂O₃, | | | |
| | about 150 nm, | | | |
| | Fe₃O₄ | | | |
| 1.75 | Emperor ® | 19.6 | 8.2 | 9.1 |
| | 2000 | | | |
| 4.5 | Support Al₂O₃, | | | |
| | about 220 nm, | | | |
| | Fe₃O₄ | | | |
| 4.5 | Support Al₂O₃, | | | |
| | about 150 nm, | | | |
| | Fe₃O₄ | | | |

The measurement results show that, with increasing proportion by weight of the flake-form effect pigment(s) in the coating, the lightness L*15 increases, but is located in the requisite value range in order to satisfy the requirement “dark or black”. By contrast, the IR reflection values in the target wavelength regions can in some cases be increased considerably compared with a layer composite having a coating which comprises only colour black.

### Example 3

The effect of the ratio of various flake-form effect pigments on the measurement results is investigated when only two flake-form effect pigments which are different from one another, but no carbon-containing black pigment, are present in a layer of the coating. The results are shown in Table 3.

TABLE 3

| | | | Reflection | Reflection |
|---|---|---|---|---|
| PMC | | | 900 ± 50 | 1550 ± 20 |
| (%) | Pigment | L*15 value | nm (%) | nm (%) |
| 13.5 | Support Al₂O₃, | 46.2 | 13.2 | 17.0 |
| | about 220 nm, | | | |
| | Fe₃O₄ | | | |
| 4.5 | Support Al₂O₃, | | | |
| | about 150 nm, | | | |
| | Fe₃O₄ | | | |
| 9.0 | Support Al₂O₃, | 46.3 | 16.4 | 15.1 |
| | about 220 nm, | | | |
| | Fe₃O₄ | | | |
| 9.0 | Support Al₂O₃, | | | |
| | about 150 nm, | | | |
| | Fe₃O₄ | | | |
| 4.5 | Support Al₂O₃, | 45.8 | 19.1 | 13.5 |
| | about 220 nm, | | | |
| | Fe₃O₄ | | | |
| 13.5 | Support Al₂O₃, | | | |
| | about 150 nm, | | | |
| | Fe₃O₄ | | | |

The results show that a flake-form effect pigment employed in accordance with the invention having an average geometrical thickness of the support particle in the range from 120 to 150 nm shifts the reflection maximum of the layer composite into the wavelength region 900±50 nm with increasing relative proportion by weight.

Overall, it can be seen that the best results with respect to the object of the present invention are achieved if equivalent parts by weight of at least two different flake-form effect pigments, optionally combined with a low proportion of carbon-containing black pigment, are employed in a single layer of the coating of the layer composite. Under these conditions, a high to very high increase in the infrared reflection in the target wavelength region compared with a comparative layer composite is obtainable at the same time as good L*15 values.

1. Use of flake-form effect pigments for increasing the infrared reflection of a dark or black layer composite consisting of a substrate and a coating on the substrate, where the coating, in addition or as an alternative to a carbon-containing black pigment, comprises at least one flake-form effect pigment which has at least one Fe₃O₄-containing layer or FeTiO₃-containing layer on a flake-form Al₂O₃ or SiO₂ support, where the layer composite has an L* 15 value in the range from 1 to 60, and where the infrared reflection of the layer composite is increased, at least in the wavelength range from 850 nm to 1570 nm, compared with a dark or black layer composite comprising a substrate and a coating where the layer composite comprises the carbon-containing black pigment, has an L*15 value in the said range and does not comprise at least one flake-form effect pigment.

2. Use according to claim 1, characterised in that the dark or black layer composite does not comprise a carbon-containing black pigment.

3. Use according to claim 1, characterised in that the carbon-containing black pigment is present in the substrate and in that the coating does not comprise the carbon-containing black pigment.

4. Use according to claim 1, characterised in that the carbon-containing black pigment and the at least one flake-form effect pigment are present together in a layer of the coating.

5. Use according to claim 1, characterised in that the carbon-containing black pigment and the at least one flake-form effect pigment are in each case present in two layers of the coating which are separated from one another.

6. Use according to one or more of claims 1 to 5, characterised in that at least two flake-form effect pigments which are different from one another and have flake-form supports which are different from one another are present in the coating.

7. Use according to one or more of claims 1 to 6, characterised in that the infrared reflection of the layer composite is increased specifically in the wavelength region 900±50 nm or in the region 1550±20 nm.

8. Use according to one or more of claims 1 to 7, characterised in that flake-form effect pigments which have a flake-form Al₂O₃ support are employed.

9. Use according to one or more of claims 1 to 8, characterised in that the substrate is a film, a plate or a moulding, in each case made from plastic, metal or a composite material, where the substrate may optionally have been pre-treated or pre-coated and the substrate and/or a pre-coating optionally comprises the carbon-containing black pigment.

10. Dark or black layer composite having increased infrared reflection, consisting of a substrate and a coating on the substrate, characterised in that the coating, in addition or as an alternative to a carbon-containing black pigment, comprises at least one flake-form effect pigment which has at least one Fe₃O₄-containing layer or FeTiO₃-containing layer on a flake-form Al₂O₃ or SiO₂ support, where the dark or black layer composite has an L*15 value in the range from 1 to 60 and where the infrared reflection of the layer composite is higher, at least in the wavelength range from 850 nm to 1570 nm, than the infrared reflection of a comparative layer composite which comprises the carbon-containing black pigment, has an L* 15 value in the said range and does not comprise at least one flake-form effect pigment.

11. Dark or black layer composite according to claim 10, characterised in that the infrared reflection, at least in the wavelength region 900±50 nm or in the wavelength region 1550±20 nm, is higher than the infrared reflection of the comparative coating.

12. Dark or black layer composite according to claim 10 or 11, characterised in that at least two flake-form effect pigments which are different from one another and which have flake-form supports which are different from one another are present in the coating.

13. Dark or black layer composite according to one or more of claims 10 to 12, characterised in that the coating does not comprise a carbon-containing black pigment.

14. Dark or black layer composite according to one or more of claims 10 to 13, characterised in that the coating comprises the carbon-containing black pigment and the at least one flake-form effect pigment in a single layer, which is optionally part of a multilayer system.

15. Dark or black layer composite according to one or more of claim 10 to 14, characterised in that the coating comprises the carbon-containing black pigment and the at least one flake-form effect pigment in each case in layers of a multilayer system which are separated from one another.

16. Dark or black layer composite according to one or more of claims 10 to 15, characterised in that the at least one flake-form effect pigment is present in a proportion of 1 to 60% by weight, based on weight of the layer, in the layer of the coating that comprises the at least one flake-form effect pigment.

17. Dark or black layer composite according to one or more of claims 10 to 16, characterised in that it is a motor vehicle part or a traffic control device.

18. Dark or black layer composite according to claim 17, characterised in that the motor vehicle part is an external bodywork part or component of a motor vehicle, and the motor vehicle has a driving assistance system or is autonomously controlled.
